(19) United States
(12) Patent Application Publication
(10) Pub. No.: US 2023/0023745 A1
(43) Pub. Date: Jan. 26, 2023

(54) KIT AND RELATED METHOD FOR BLENDING AN ALCOHOLIC SPIRIT

(71) Applicant: SACHA ELEZ, BROWNLEE (CA)

(72) Inventor: SACHA ELEZ, BROWNLEE (CA)

(21) Appl. No.: 17/714,230

(22) PCT Filed: Nov. 18, 2020
(86) PCT No.: PCT/CA2020/051573

§ 371 Date: Apr. 6, 2022

Related U.S. Application Data
(60) Provisional application No. 62/938,422, filed on Nov. 21, 2019.

(51) Int. Cl. C12G 3/06; A47J 43/27

(52) U.S. Cl. CPC C12G 3/06; A47J 43/27; A47J 2203/00

(57) ABSTRACT

A kit and related method for preparing an alcoholic spirit for subsequent consumption generally comprises: a blending container in which the alcoholic spirit is to be mixed, and a predetermined amount of ethanol less than the volume of the blending container received therein and having a relatively high alcohol percentage generally not suited for consumption. This leaves a portion of the volume of the blending container to receive a prescribed amount of water such that the alcoholic spirit can be formed in the blending container, by mixing of the ethanol and the water, with an alcohol percentage which is less than the alcohol percentage of the ethanol.

### FIELD OF THE INVENTION

The present invention relates to a method of blending an alcoholic spirit suited for consumption.

### BACKGROUND

It may be desirable to form an alcoholic spirit having an alcohol percentage of between 20% and 40% so as to be better suited for consumption from ethanol which has an alcohol percentage greater than 60%.

### SUMMARY OF THE INVENTION

According to an aspect of the invention there is provided a method for preparing an alcoholic spirit for subsequent consumption comprising:

providing a blending container with a predetermined amount of ethanol which is less than a volume of the blending container, the ethanol having an alcohol percentage of at least about 60%;

transferring a prescribed amount of water into the blending container having the predetermined amount of ethanol therein so that the alcoholic spirit can be formed having an alcohol percentage of about 15% to about 50%; and

mixing the predetermined amount of ethanol and the predetermined amount of water in the blending container so as to form the alcoholic spirit.

Preferably, the alcohol percentage of the ethanol is at least about 70% or 75%.

Preferably, the alcohol percentage of the ethanol is at least about 80% or 85%.

Preferably, the alcohol percentage of the alcoholic spirit is between about 17% and about 46%.

Preferably, the alcohol percentage of the alcoholic spirit is between about 20% and about 40%.

In one arrangement, the predetermined amount of ethanol is between about 100 mL and about 400 m L.

Preferably, the predetermined amount of ethanol is between about 150 mL and about 300 m L.

In one arrangement, the predetermined amount of ethanol is between one-tenth and one-half of the volume of the blending container.

In one arrangement, transferring the prescribed amount of water into the blending container comprises transferring water to a water fill line indicated on the blending container.

Preferably, the water fill line is arranged at a location beneath a neck of the blending container so as to leave an air gap for mixing when the predetermined amount of ethanol and the prescribed amount of water are received in the blending container.

In one arrangement, the method further includes:

providing a flavour additive which is mixable with the ethanol; and

transferring a prescribed amount of the flavour additive into the blending container having the predetermined amount of ethanol therein, so that the prescribed amount of the flavour additive can be mixed therewith and with the prescribed amount of water.

In one such arrangement, transferring the prescribed amount of the flavour additive comprises transferring a premeasured amount of the flavour additive into the blending container.

The flavour additive may be in the form of a liquid.

Typically, the flavour additive is non-alcoholic.

Preferably, the step of transferring the prescribed amount of water into the blending container is performed immediately before the step of mixing the predetermined amount of ethanol in the blending container, such that the blending container is sealed immediately after the prescribed amount of water has been transferred so as to minimize escape of vapour which can be emitted when the water mixes with the ethanol during the step of transferring the prescribed amount of water into the blending container.

In one arrangement, the blending container defines interior surfaces, which are exposed to the ethanol and the water to be mixed, that are substantially perpendicularly oriented to a height direction of the blending container, which is directed between a bottom of the blending container adapted for resting on a support surface and an opposite top thereof, so as to enhance the step of mixing the predetermined amount of ethanol in the blending container.

In one such arrangement, the substantially perpendicularly oriented interior surfaces are located along an outer periphery of the blending container.

In one such arrangement, the substantially perpendicularly oriented interior surfaces are formed by outwardly projecting protrusions and inwardly projecting recesses defined by an exterior wall of the blending container.

According to another aspect of the invention there is provided a kit for preparing an alcoholic spirit for subsequent consumption comprising:

a blending container in which the alcoholic spirit is to be mixed;

a predetermined amount of ethanol less than a volume of the blending container and having an alcohol percentage of at least about 60%, the predetermined amount of ethanol being received in the blending container so as to leave a portion of the volume of the blending container to receive a prescribed amount of water such that the alcoholic spirit can be formed in the blending container, by mixing of the ethanol and the water, with an alcohol percentage which is less than the alcohol percentage of the ethanol.

In one arrangement, the predetermined amount of ethanol is between about 100 mL and about 400 m L.

In one arrangement, the predetermined amount of ethanol is between about one-tenth and about one-half of the volume of the blending container.

In one arrangement, the kit further includes a prescribed amount of flavour additive received in a separate storage container from the blending container, such that the flavour additive is transferred from the separate storage container and into the blending container for mixing with the ethanol.

The flavour additive may be in the form of a liquid.

Preferably, the prescribed amount of flavour additive is a premeasured amount based on a volume of the alcoholic spirit to be prepared, such that all of the flavour additive in the separate storage container is transferred into the blending container for mixing.

In one arrangement, the blending container includes a water fill line which is located at a spaced height below a top of the neck of the blending container, so as to leave an air gap for mixing when the predetermined amount of ethanol and the prescribed amount of water are received in the blending container.

In one arrangement, the blending container defines interior surfaces, which are exposed to the ethanol and the water to be mixed, that are substantially perpendicularly oriented to a height direction of the blending container, which is directed between a bottom of the blending container adapted for resting on a support surface and an opposite top thereof, so as to enhance the step of mixing the predetermined amount of ethanol in the blending container.

In one such arrangement, the substantially perpendicularly oriented interior surfaces are located along an outer periphery of the blending container.

In one such arrangement, the substantially perpendicularly oriented interior surfaces are formed by outwardly projecting protrusions and inwardly projecting recesses defined by an exterior wall of the blending container.

In other words, it is an aspect of the invention to provide a kit and related method for preparing an alcoholic spirit for subsequent consumption generally comprising: a blending container in which the alcoholic spirit is to be mixed, and a predetermined amount of ethanol less than the volume of the blending container received therein and having a relatively high alcohol percentage generally not suited for consumption. This leaves a portion of the volume of the blending container to receive a prescribed amount of water such that the alcoholic spirit can be formed in the blending container, by mixing of the ethanol and the water, with an alcohol percentage which is less than the alcohol percentage of the ethanol.

### BRIEF DESCRIPTION OF THE DRAWINGS

The invention will now be described in conjunction with the accompanying drawings in which:

FIG. 1 is a schematic illustration of a kit for preparing an alcoholic spirit according to an arrangement of the present invention.

In the drawings like characters of reference indicate corresponding parts in the different figures.

### DETAILED DESCRIPTION

With reference to the accompanying figures, there is disclosed herein a kit and related method for preparing an alcoholic spirit for subsequent consumption.

The kit, which is indicated at 10, comprises a blending container 12 in which the alcoholic spirit is to be mixed. The blending container 12 is rigid in shape and made from a food-grade material which is able to withstand ethanol having a high concentration of alcohol, by volume, without degrading and/or leaching chemicals into contents received in the container. For example, the material of the blending container may be glass or polyethylene terephthalate (PET) plastic.

The kit 10 additionally includes a predetermined amount of ethanol 15 less than a volume of the blending container 12 and having an alcohol percentage of at least about 60%. The predetermined amount or volume of the ethanol is based on the volume of the blending container 12, and the alcohol percentage of the ethanol, such that the alcoholic spirit prepared therefrom has an alcohol percentage lying in a range suitable and safe for consumption, and which is not toxic, which is normally between about 15% to about 50%. The predetermined amount of ethanol for conventionally sized containers in which alcoholic spirits are usually sold is generally between about 150 mL and about 300 mL for a 750 mL blending container when the alcohol percentage of the ethanol is greater than or equal to about 60%. The predetermined amount of ethanol is between about one-tenth and about one-half of the volume of the blending container 12.

It will be appreciated that the alcohol percentage of the ethanol may be greater than or equal to 70%, 75%, 80% or 85% while providing similar functionality. In such cases, for a prescribed alcohol percentage of the alcoholic spirit, for example 40%, a smaller amount of the ethanol is provided.

It also will be appreciated that the alcohol percentage of the alcoholic spirit may be between a narrower range of about 17% to about 46%, or even about 20% to about 40%, while providing similar functionality. This may depend on the potency desired by the end-user who will be consuming the alcoholic spirit.

The blending container 12 is provided to the end-user with the predetermined amount of ethanol 15 received therein. As the predetermined amount of ethanol is generally significantly smaller than the volume of the blending container, this leaves a majority portion of the volume of the blending container 12 to receive a prescribed amount of water 18 from an external source 20, such as from a mains water supply or from a water jug, such that the alcoholic spirit can be formed directly in the blending container 12 without transferring the ethanol out of this container for mixing or blending in another container. The resultant alcoholic spirit produced from mixing the predetermined amount of ethanol with the prescribed amount of water has an alcohol percentage which is less than the alcohol percentage of the ethanol. Typically the alcohol percentage of the blended alcoholic spirit is about 20% to about 40% per volume, which encompasses the range of the majority of alcoholic spirits which are commercially available to the public.

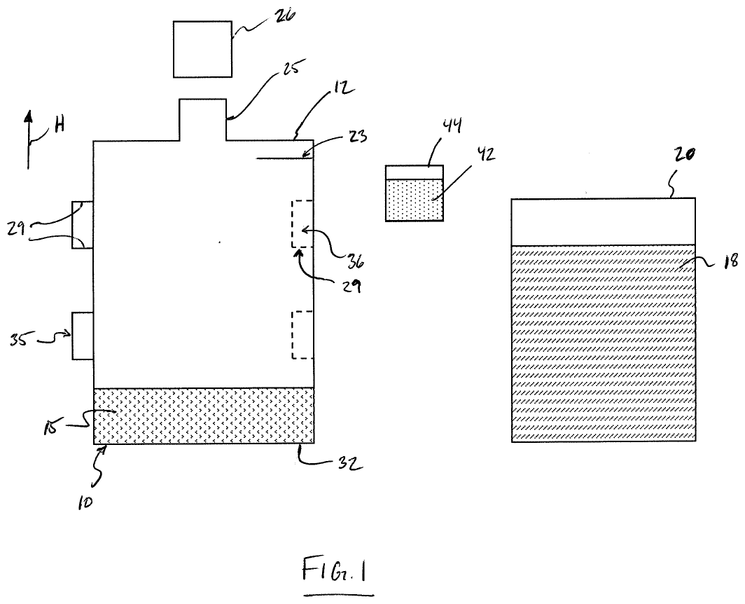

Generally speaking, the prescribed amount of water is not premeasured such that the prescribed amount of water to be added into the blending container 12 is indicated by a water fill line 23 provided on the blending container 12 which is translucent, and preferably transparent. The water fill line 23 is located at a spaced height below a top of the neck 25 of the blending container where there is defined an access opening through which an interior of the container is communicated with an outside of the container, and preferably the fill line 23 is located below a bottom of the neck as shown in FIG. 1, so as to leave an air gap for mixing when the predetermined amount of ethanol 15 and the prescribed amount of water 18 are both received inside the blending container. The blending container 12 usually includes a cap or other closure member 26 which is removably received on the neck 25 to close the access opening and substantially seal the interior of the blending container 12.

In the illustrated arrangement, the blending container 12 defines interior surfaces indicated at 29, which are exposed to the ethanol 15 and the water 18 to be mixed, that are substantially perpendicularly oriented to a height direction H of the blending container, which is directed between a bottom 32 of the blending container adapted for resting on a support surface such as a tabletop and an opposite top thereof which is normally defined by the neck 25, so as to enhance mixing in the blending container. The substantially perpendicularly oriented interior surfaces 29 are located along an outer periphery of the blending container 12 and are formed by outwardly projecting protrusions 35 and inwardly projecting recesses 36 defined by an exterior wall 38 of the blending container which defines the container's outer periphery. The protrusions and recesses 35, 36 are located at spaced positions on the exterior wall 38 and may be arranged so as to define mating male and female connectors so that bottles of the same type can be interconnected to each other.

The kit 10 may additionally include a prescribed amount of flavour additive 42 which is mixable with the ethanol 15. Normally the ethanol is provided in a pure, flavourless condition leaving open the possibility to form flavourless vodka, or a flavoured alcoholic spirit such as whisky or a rum styled beverage. The flavour additive 42 is in the form of a liquid and is received in a separate storage container 44 from the blending container 12, such that the flavour additive 42 is transferred from the separate storage container 44 and into the blending container 12 for mixing with the ethanol therein. The flavour additive 42 is typically sold separately of the blending container 12 with the predetermined amount of ethanol 15, and thus may be provided by a different manufacturer from that providing the basic kit including the container 12 with the ethanol 15. The prescribed amount of flavour additive 44 is a premeasured amount based on a volume of the alcoholic spirit to be prepared in the blending container, such that all of the flavour additive 42 in the separate storage container 44 is transferred into the blending container for mixing.

The kit 10 relates to a method for preparing an alcoholic spirit for subsequent consumption which comprises the steps of:

providing a blending container 12 with a predetermined amount of ethanol 15 which is less than a volume of the blending container, the ethanol 15 having an alcohol percentage of at least 60%;

transferring a prescribed amount of water 18 into the blending container 12 having the predetermined amount of ethanol 15 therein so that the alcoholic spirit can be formed having an alcohol percentage per volume of about 15% to about 50%; and

mixing the predetermined amount of ethanol and the predetermined amount of water in the blending container so as to form the alcoholic spirit with the alcohol percentage which is less than that of the ethanol.

In the illustrated arrangement, the step of transferring the prescribed amount of water into the blending container 12 comprises transferring the water 18 to a water fill line 23 indicated on the blending container so that the prescribed amount of water does not have to be premeasured.

Generally speaking, the prescribed amount of water is greater than the predetermined amount of ethanol, in terms of volume, particularly when it is desired to lower the alcohol percentage of the alcoholic spirit by more than half of the alcohol percentage of the ethanol.

If it is desired to form a flavoured alcoholic spirit then the method also includes the steps of:

providing a flavour additive 42 which is mixable with the ethanol 15; and

transferring a prescribed amount of the flavour additive into the blending container having the predetermined amount of ethanol therein, so that the prescribed amount of the flavour additive can be mixed therewith and with the prescribed amount of water.

The step of transferring the prescribed amount of the flavour additive comprises transferring a premeasured amount of the flavour additive into the blending container.

Regardless of whether or not the user adds the flavouring into the blending container, the step of transferring the prescribed amount of water into the blending container is performed immediately before the step of mixing the predetermined amount of ethanol 15 in the blending container 12 with the other contents received therein, such that the blending container 12 is sealed with the cap 26 immediately after the prescribed amount of water 18 has been transferred and thus introduced into the blending container 12 so as to minimize escape of vapour which is emitted when the water 18 mixes with the ethanol 15 during the step of transferring the prescribed amount of water into the blending container. That is, a chemical reaction takes place when the water 18 mixes with the ethanol which may cause heat to be released, allowing the ethanol to be more easily vaporized and consequently escape an open container, thus reducing the potency or alcohol percentage of the resultantly formed spirit.

Generally speaking, the predetermined amount of ethanol 15, which is based on the alcohol percentage of the ethanol used, that is provided is dependent on the alcohol percentage of the alcoholic spirit to be formed. Similarly, the prescribed amount of water to be added to the blending container 12 is dependent on the alcohol percentage of the alcoholic spirit to be formed. Thus, the kit can be sold to the end-user as a kit for forming an alcoholic spirit of a prescribed alcohol percentage, for example 40%, and all that the user is left to do is to add water in the prescribed amount, which is predetermined by the kit provider/manufacturer and indicated by instructions provided to the end-user in the form of a visual fill line.

Thus is provided an arrangement for a user to prepare an alcoholic spirit of an alcohol percentage by volume which is safe for normal consumption by providing a single container with a predetermined amount of ethanol already therein, which has a relatively high alcohol percentage not considered suitable for direct consumption, so that all that the end-user is required to do is to add water and optionally add flavouring to this container and let these ingredients mix together therein in order to form the alcoholic spirit.

The scope of the claims should not be limited by the preferred embodiments set forth in the examples but should be given the broadest interpretation consistent with the specification as a whole.

1. A method for preparing an alcoholic spirit for subsequent consumption comprising:
providing a blending container with a predetermined amount of ethanol which is less than a volume of the blending container, the ethanol having an alcohol percentage of at least about 60%;
transferring a prescribed amount of water into the blending container having the predetermined amount of ethanol therein so that the alcoholic spirit can be formed having an alcohol percentage of about 15% to about 50%; and
mixing the predetermined amount of ethanol and the predetermined amount of water in the blending container so as to form the alcoholic spirit.

2. The method of claim 1 wherein transferring the prescribed amount of water into the blending container comprises transferring water to a water fill line indicated on the blending container.

3. The method of claim 2 wherein the water fill line is arranged at a location beneath a neck of the blending container so as to leave an air gap for mixing when the predetermined amount of ethanol and the prescribed amount of water are received in the blending container.

4. The method of claim 1 further including:
providing a flavour additive which is mixable with the ethanol; and
transferring a prescribed amount of the flavour additive into the blending container having the predetermined amount of ethanol therein, so that the prescribed amount of the flavour additive can be mixed therewith and with the prescribed amount of water.

5. The method of claim 4 wherein transferring the prescribed amount of the flavour additive comprises transferring a premeasured amount of the flavour additive into the blending container.

6. The method of claim 4 wherein the flavour additive is in the form of a liquid.

7. The method of claim 4 wherein the flavour additive is non-alcoholic.

8. The method of claim 1 wherein the step of transferring the prescribed amount of water into the blending container is performed immediately before the step of mixing the predetermined amount of ethanol in the blending container, such that the blending container is sealed immediately after the prescribed amount of water has been transferred so as to minimize escape of vapour which can be emitted when the water mixes with the ethanol during the step of transferring the prescribed amount of water into the blending container.

9. The method of claim 1 wherein the blending container defines interior surfaces, which are exposed to the ethanol and the water to be mixed, that are substantially perpendicularly oriented to a height direction of the blending container, which is directed between a bottom of the blending container adapted for resting on a support surface and an opposite top thereof, so as to enhance the step of mixing the predetermined amount of ethanol in the blending container.

10. The method of claim 9 wherein the substantially perpendicularly oriented interior surfaces are located along an outer periphery of the blending container.

11. The method of claim 9 wherein the substantially perpendicularly oriented interior surfaces are formed by outwardly projecting protrusions and inwardly projecting recesses defined by an exterior wall of the blending container.

12. The method of claim 1 wherein the predetermined amount of ethanol is between about 100 mL and about 400 mL.

13. The method of claim 1 wherein the predetermined amount of ethanol is between about one-tenth and about one-half of the volume of the blending container.

14. A kit for preparing an alcoholic spirit for subsequent consumption comprising:
a blending container in which the alcoholic spirit is to be mixed;
a predetermined amount of ethanol less than a volume of the blending container and having an alcohol percentage of at least about 60%, the predetermined amount of ethanol being received in the blending container so as to leave a portion of the volume of the blending container to receive a prescribed amount of water such that the alcoholic spirit can be formed in the blending container, by mixing of the ethanol and the water, with an alcohol percentage which is less than the alcohol percentage of the ethanol.

15. The kit of claim 14 further including a prescribed amount of flavour additive received in a separate storage container from the blending container, such that the flavour additive is transferred from the separate storage container and into the blending container for mixing with the ethanol.

16. The kit of claim 15 wherein the flavour additive is in the form of a liquid.

17. The kit of claim 15 wherein the prescribed amount of flavour additive is a premeasured amount based on a volume of the alcoholic spirit to be prepared, such that all of the flavour additive in the separate storage container is transferred into the blending container for mixing.

18. The kit of claim 14 wherein the blending container includes a water fill line which is located at a spaced height below a top of the neck of the blending container, so as to leave an air gap for mixing when the predetermined amount of ethanol and the prescribed amount of water in the blending container.

19. The kit of claim 14 wherein the blending container defines interior surfaces, which are exposed to the ethanol and the water to be mixed, that are substantially perpendicularly oriented to a height direction of the blending container, which is directed between a bottom of the blending container adapted for resting on a support surface and an opposite top thereof, so as to enhance the step of mixing the predetermined amount of ethanol in the blending container.

20. The kit of claim 19 wherein the substantially perpendicularly oriented interior surfaces are located along an outer periphery of the blending container.

21. The kit of claim 19 wherein the substantially perpendicularly oriented interior surfaces are formed by outwardly projecting protrusions and inwardly projecting recesses defined by an exterior wall of the blending container.

22. The kit of claim 14 wherein the predetermined amount of ethanol is between about 100 mL and about 400 mL.

23. The kit of claim 14 wherein the predetermined amount of ethanol is between about one-tenth and about one-half of the volume of the blending container.
